(19) United States
(12) Patent Application Publication
(10) Pub. No.: US 2004/0254910 A1
(43) Pub. Date: Dec. 16, 2004

(54) Method and arrangement for configuring modules in a data processing system

(75) Inventor: Michael Tiegelkamp, Pyrbaum (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/781,669

(22) Filed: Feb. 20, 2004

Related U.S. Application Data
(63) Continuation of application No. PCT/DE02/03010, filed on Aug. 16, 2002.

(30) Foreign Application Priority Data
Aug. 20, 2001 (DE) 101 40 763.7

(51) Int. Cl. G06F 7/00

(52) U.S. Cl. 707/1

(57) ABSTRACT

A method and an arrangement for configuration of components in a data processing unit, in particular for controlling or regulating a technical plant. Decentralized and centralized components (1,3), which are networked together, take on a memory-programmable control of plant functions. Plant components (1) each include a configuration module (4), via which a projection and/or parameterization of the relevant component with regard to the controlled function is carried out. The components (1,3) can carry out an exchange of data and/or program components, via the internal network (2) and/or external network (8), to support the configuration.

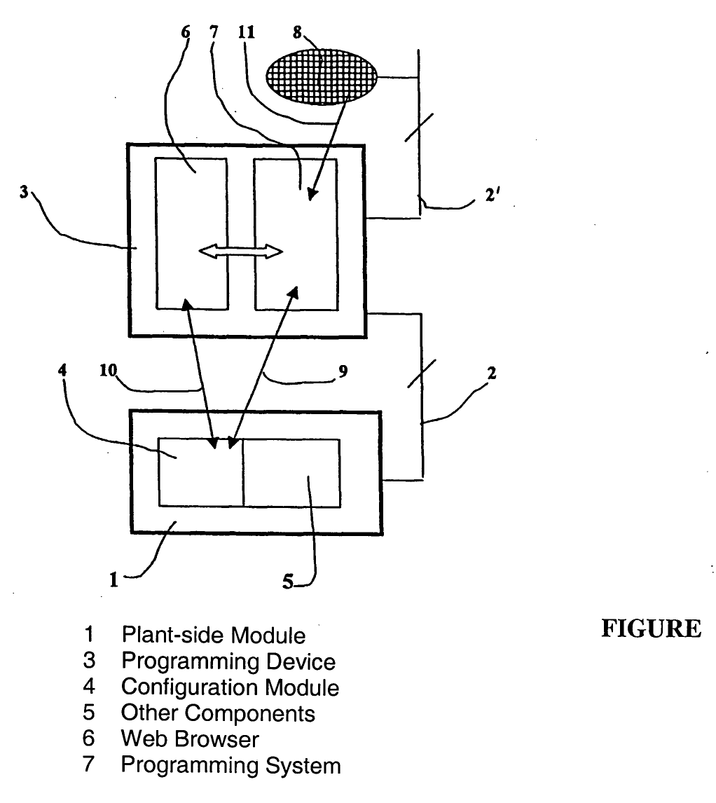

This is a Continuation of International Application PCT/DE02/03010, with an international filing date of Aug. 16, 2002, which was published under PCT Article 21(2) in German, and the disclosure of which is incorporated into this application by reference.

### FIELD OF AND BACKGROUND OF THE INVENTION

The invention relates to a method and an arrangement for configuring modules in a data processing system, e.g., for configuring and/or parameterizing the modules in a technical plant.

Program modules or other software tools installed in a separate, e.g. conventional, programming device, such as a personal computer, are commonly used to program and configure stored program controllers. These software tools are used to program the controllers with a so-called editor, for uploading or downloading data or program parts and creating memory cards or other memory components, e.g., EPROMs or the like.

These software tools are further used to configure the hardware modules on the controller side as well as to start up, troubleshoot and maintain the entire technical plant in which the stored program controller is used. The configuration and diagnosis alone of each hardware module in the plant to be controlled requires the installation in the programming device not only of the programming languages used for this purpose, e.g., STEP 7, but also of relatively extensive special configuration software tools. These software tools must in addition include drivers for the memory components and for the network cards that are used to network the corresponding centralized and decentralized hardware modules, e.g., in a hardware configuration within STEP 7.

To adapt these software tools to the changing conditions of the plant or to a further development of the hardware or software modules, the software has to be renewed relatively frequently, i.e., the manufacturer of the stored program controllers must centrally update all the configuration software tools and distribute them to the users. To adapt the controller to the new conditions, the user must then update or reinstall the controller in the technical plant, including, in particular, the different hardware modules, typically using a programming device.

### OBJECTS OF THE INVENTION

Thus, objects of the invention include providing a method and an arrangement for configuring modules in a data processing system of the initially described type in such a way as to enable a simple configuration of the modules.

### SUMMARY OF THE INVENTION

According to one formulation of the invention, these and other objects are attained by a method, a software or firmware module, or a correspondingly structured data processing system, particularly for open-loop or closed-loop control of a technical plant, in which modules assume the stored-program control of plant functions. To program the plant functions, a personal computer working as a programming device is usually provided and can be connected with the plant-side modules, which may be decentrally and centrally networked with one another. According to the invention, however, the modules each advantageously have a configuration component that can be used to configure and/or parameterize the corresponding module with regard to the function to be controlled. For this purpose, hardware configuration software is preferably provided on the controller itself or, more generally, in each module. This has advantages, as described further below, both for the manufacturer of the controller and for the user, and makes possible an open distributed automation system.

To support the configuration, the modules can advantageously exchange data and/or program parts via the internal network and/or via an external network. For this purpose, the aforementioned modules can be simply connected to the respectively other modules via a standardized network connection. The modules can also be connected to the World Wide Web or the Internet via a likewise standardized network connection and a software component acting as a browser.

To support the configuration of a plant-side module using a programming device, which is known per se, the programming device can have a configuration module that is largely identical with the decentralized configuration module. The plant-side modules preferably have a microprocessor and memory chips with which the respective module can be configured.

In summary, the method according to the invention and the arrangements proposed therefor offer a number of advantages, in that each module provides the configuration software required for it, i.e., the configuration software is available at any time. The user does not necessarily need to procure and install a newer version of this software, but has the option to update the software during fault recovery and/or in case of new functions. Since this software can be separately updated and reloaded, the user can concentrate on the new module during such an update while leaving the other modules untouched.

The user of the method according to the invention is able to configure the modules by simple means without a major effort with respect to the display and change in data or program parts and using relatively simple devices, particularly the programming devices, and relatively simple software. It is furthermore possible to generate device-dependent settings for parameterization, so-called online changes, during operation and to display diagnostics with a predefined technological presentation without thereby burdening the entire software in a central programming device with additional software options. The data exchange with this central module can take place via standardized interfaces in both directions.

Advantages also result in the production of such stored program controllers because the hardware production is decoupled from the software production. As a result, the delivery of such intelligent modules can be planned more independently because each module itself includes the required configuration software. The proposed decoupling of the programming and the configuration of the modules also reduces the complexity of integration and system tests of the entire plant, including the creation, maintenance and logistics of the hardware configuration software.

To improve the so-called offline configurability of the system, it is further proposed, as mentioned above, to make the hardware configuration software available also on the central programming device in essentially identical form. To this end, the user can transfer this software to the programming device from the Internet, a compact disk or other storage media or even from the module itself. For this purpose, the modules are preferably equipped with a standard Ethernet interface with TCP/IP protocol for an Ethernet bus as a so-called field bus as well as a Web server, which enables the open connection of any Web clients, i.e., typically via a standard Web browser for the Internet.

According to the invention, the standard programming software for the programming devices, e.g., STEP 7 or high-level programming languages, is more strongly decoupled from the basic hardware performance, e.g., the hardware configuration within STEP 7, of the decentralized modules. The module-specific intelligence is located on the side of the controller in the automation system. As a result, in contrast to the conventional methods used today, modified programming packets on a STEP 7 basis can also be better handled overall even in a relatively large project because the total information can be distributed among all the controllers.

### BRIEF DESCRIPTION OF THE DRAWINGS

The invention will now be described in greater detail, by way of example, with reference to an embodiment for carrying out the method depicted in the drawing. The single FIGURE shows a basic block diagram of a stored program controller with a programming device and with a plant-side module containing hardware configuration software.

### DETAILED DESCRIPTION OF THE PREFERRED EMBODIMENTS

The figure schematically shows a module 1 representing a part of a controller in an automation system. The module 1 is connected with a programming device 3, usually a personal computer, via a bus system 2, e.g., a field bus, a Profibus or a bus system with an Ethernet protocol. Here, the programming device 3 is also connected with other modules (not depicted) and with the Internet 8 via an Ethernet bus 2′.

The plant-side module 1 has a configuration module, preferably in the form of hardware configuration software 4, which is used to configure and/or parameterize the module 1 via an internal microprocessor with respect to the function to be controlled in the automation system and/or in the technical plant. Other hardware or software components 5 required for the control tasks are provided in addition.

As indicated schematically, the central programming device 3 includes a standard Web browser 6 and the programming system 7 of the automation system, e.g., as the software package STEP 7. To support the configuration in the decentralized module 1, a configuration module that is largely identical with the decentralized configuration module 4 is provided in the programming system 7, as schematically indicated by arrow 9.

To support the configuration, the module 1 can also exchange data and/or program parts by means of the bus system 2 via the internal network and/or via the external network. These exchange procedures are schematically indicated by arrow 10 for the connection of the configuration module 4 via the Web browser 6 and by an arrow 11 for the connection to the Internet 8.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A method for configuring modules in a data processing system, for controlling a technical plant, comprising:
utilizing decentralized and centralized modules that are networked with one another to provide a stored program control of plant functions, wherein the decentralized, plant-side modules each have a respective configuration module; and
for one of the plant functions to be controlled, at least one of configuring and parameterizing the plant-side modules with the respective configuration modules.

2. The method as claimed in claim 1, wherein the control of the technical plant comprises an open-loop control.

3. The method as claimed in claim 1, wherein the control of the technical plant comprises a closed-loop control.

4. The method as claimed in claim 1, wherein the networked modules exchange at least one of data and program parts via at least one of an internal and an external network, to support the configuration.

5. The method as claimed in claim 1, further comprising supporting the configuration of the plant-side modules using a programming device equipped with a configuration module that is essentially identical to at least one of the configuration modules of the plant-side modules.

6. A component structured to configure a module in a data processing system, for controlling a technical plant, in which system decentralized and centralized modules are networked with one another to provide a stored program control of plant functions, wherein the decentralized, plant-side modules each have a respective configuration module, comprising:
hardware configuration software with which at least one of the plant-side modules corresponding to the component is at least configured or parameterized.

7. The component according to claim 6, wherein the component comprises a software component.

8. The component according to claim 6, wherein the component comprises a firmware component.

9. A circuit arrangement for configuring a module in a data processing system, for controlling a technical plant, in which system decentralized and centralized modules are networked with one another to provide a stored program control of plant functions, wherein the decentralized, plant-side modules each comprise a configuration module, and wherein the decentralized, plant-side modules each comprise a microprocessor and memory components for configuring the respective plant-side module.

10. The circuit arrangement as claimed in claim 9, further comprising:
a standardized network connection for interconnecting the respective plant-side modules with one another; and
a further standardized network connection with a software component configured as a browser for connecting the respective plant-side modules to an Internet.
